(19) United States
(12) Patent Application Publication
(10) Pub. No.: US 2026/0168867 A1
(43) Pub. Date: Jun. 18, 2026

(54) AUTOMATED CALIBRATION FOR DISTRIBUTED TEMPERATURE SENSING (DTS) SYSTEMS

(71) Applicant: Precise Downhole Services Ltd., Edmonton (CA)

(72) Inventors: Ronny Neufeld, Edmonton (CA); Sean Begley, Edmonton (CA); Murtaza Rampurawala, Edmonton (CA); Michael Melnychuk, Edmonton (CA); Aleksei Andriianov, Edmonton (CA); Daniel Keough, Edmonton (CA)

(21) Appl. No.: 19/421,865

(22) Filed: Dec. 16, 2025

Related U.S. Application Data
(60) Provisional application No. 63/735,107, filed on Dec. 17, 2024.

(51) Int. Cl. G01K 15/00; E21B 47/07; G01K 1/02; G01K 11/324

(52) U.S. Cl. CPC G01K 15/005; E21B 47/07; G01K 1/026; G01K 11/324; G01K 2213/00

(57) ABSTRACT

Disclosed examples relate to a method and system for applying automated calibration (i.e., autocalibration) to distributed temperature sensing (DTS) measurements. In some examples, there is provided a method for automated calibration of distributed temperature sensing (DTS) measurements, comprising receiving, at a switching unit, sequence increment data from a DTS module used for acquiring DTS measurements in a downhole well; identifying, at the switching unit, a next entry in a sequence-channel listing stored in the switching unit; adjusting a switching configuration of the switching unit to couple the identified input temperature channel to an output interface of the switching unit, the output interface being coupled to the DTS module; and transmitting calibration temperature data through the switching unit from the at least one temperature sensor to the DTS module to allow automatic calibration of the DTS measurements by the DTS module.

### CROSS-REFERENCE TO RELATED APPLICATION(S)

This application claims the benefit of U.S. Provisional Application No. 63/735,107, filed on Dec. 17, 2024, the entire contents of which are hereby incorporated by reference.

### FIELD

Disclosed examples generally relate to distributed temperature sensing (DTS) technology, and in particular, to applying automated calibration (i.e., autocalibration) to distributed temperature sensing (DTS) systems. In some examples, the autocalibration is applied in real time or near real time.

### BACKGROUND

Distributed temperature sensing (DTS) systems provide continuous temperature monitoring using fiber-optic cables. The technology is used for temperature monitoring over long distances, including along pipelines, tunnels and power cables. It also has significant application in the oil and gas industry, where monitoring temperature is often required in deep downhole wells.

When using DTS systems, calibration remains a significant challenge for accurate temperature measurements. Key issues with calibration include external environmental variations, sensor drift, and non-uniform optical fiber responses.

### SUMMARY

In at least one broad example, there is provided a method for automated calibration of distributed temperature sensing (DTS) measurements, comprising receiving, at a switching unit, sequence increment data from a DTS module used for acquiring DTS measurements in a downhole well; identifying, at the switching unit, a next entry in a sequence-channel listing stored in the switching unit, wherein the next entry specifies an input temperature channel of the switching unit to probe, the input temperature channel being coupled to at least one temperature sensor in the downhole well; adjusting a switching configuration of the switching unit to couple the identified input temperature channel to an output interface of the switching unit, the output interface being coupled to the DTS module; and transmitting calibration temperature data through the switching unit from the at least one temperature sensor to the DTS module to allow automatic calibration of the DTS measurements by the DTS module.

In another broad example, there is provided a switching unit comprising a plurality of input temperature channels, each channel couplable to at least one temperature sensor in a downhole well; an output interface and a data interface, each couplable to a DTS module; a switching interface for coupling one of the input temperature channels to the output interface; at least one processor coupled to at least one memory and the switching interface; and the at least one memory storing a sequence-channel listing and computer-executable instructions which, when executed by the at least one processor, cause the at least one processor to receive sequence increment data from the DTS module via the data interface, identify a next entry in the sequence-channel listing specifying an input temperature channel associated with a given downhole well to probe, adjust a switching configuration of the switching interface to couple the input temperature channel to the output interface, and transmit calibration temperature data from the input temperature channel to the DTS module to allow automatic calibration of DTS measurements acquired by the DTS module for the given downhole well.

In still another broad example, there is provided a system for automated calibration of distributed temperature sensing (DTS) measurements, comprising the switching unit described herein and a DTS module coupled to the switching unit.

In different embodiments, the present invention may comprise a method or system comprising any combination of elements or features described herein, or which specifically omits any particular feature or element described herein.

### BRIEF DESCRIPTION OF THE DRAWINGS

In the drawings, like elements may be assigned like reference numerals. The drawings are not necessarily to scale, with the emphasis instead placed upon the principles of the present disclosure. Additionally, each of the embodiments depicted are but one of a number of possible arrangements utilizing the fundamental concepts of the present disclosure.

FIG. 1 is an example oil and gas well environment in which the disclosed examples may be applied.

FIG. 2A is a simplified representation of a distributed temperature sensing (DTS) system.

FIG. 2B is an illustration of an example input interface for an example DTS module.

FIG. 3 is an example temperature profile plot generated using a DTS system, before and after applying autocalibration.

FIG. 4 is an example system for automated DTS calibration.

FIG. 5A is a process flow for operating a switching unit for automated DTS calibration.

FIG. 5B is a process flow for a further example method for operating a switching unit for automated DTS calibration.

FIG. 5C is a process flow for operating a DTS module for automated DTS calibration in real time or near real time.

FIG. 6 is an example hardware architecture for a switching unit.

### DETAILED DESCRIPTION

Embodiments herein generally relate to a method and system for applying automated calibration (i.e., autocalibration) to distributed temperature sensing (DTS) systems. In some examples, the autocalibration is applied in real time or near real time.

### I. Definitions

Any term or expression not expressly defined herein shall have its commonly accepted definition understood by a person skilled in the art. As used herein, the following terms have the following meanings.
“Automatic calibration” or “autocalibration” refers to calibration performed without manual intervention, where a system autonomously acquires relevant inputs, computes calibration parameters, and applies those parameters to measurement data according to predefined rules or algorithms, optionally in real time or near real time.
“Distributed temperature sensing (DTS) systems” refer to a class of systems, which are known in the art, that use Raman scattering and rely on the interaction of laser light with optical fibers (also referred herein interchangeably as “fiber-optic cables”) to measure temperature along the fiber's length.
“DTS measurement” or “DTS temperature measurement” means a temperature value or profile derived from analyzing backscattered signals along a fiber-optic cable, representing temperature as a function of position along the cable.
“DTS module” refers to the signal processing unit of a DTS system that generates laser pulses, receives backscattered signals (e.g., Raman Stokes and anti-Stokes signals) from an input fiber-optic channel, processes those signals to produce a temperature profile along the fiber's length, and interfaces with external inputs. While referenced herein as a single module, it may include more than one module or submodule.
“Preset” or “predefined” value means a predefined reference value stored in a component's memory and used to indicate or verify a known condition or state (e.g., a fixed fiber length, threshold, or identifier) during operation.
“Processor” includes one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors. Reference herein to a component performing a given function indicates that a processor of the component is executing computer-executable instructions stored on a memory of that component.
“Real time or near real time” means actions or processes performed either instantaneously after receiving specific inputs, or within a very short timeframe, typically measured in seconds (e.g., within 0.0001 to 5 seconds).
“Sequence-channel listing” means a sequential mapping stored in memory that specifies, for each sequence position, the particular input channel to be selected or probed, thereby controlling which source of measurement data is active at a given sequence increment.
“Sequence increment data” means information indicating that the current sequence position has advanced to the next entry in a sequence-channel listing, enabling the system to update which input channel is selected or probed at the new sequence position.
“Switching configuration” means the current selection state of a switching interface that defines which input temperature channel of a switching unit is coupled to an output interface of the switching unit, as explained below.
“Memory” includes a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

### II. General Overview

As noted above, DTS technology is used in various applications requiring temperature monitoring over long distances. In the context of oil and gas wells, DTS technology is used for monitoring temperatures along the length of deep downhole wells.

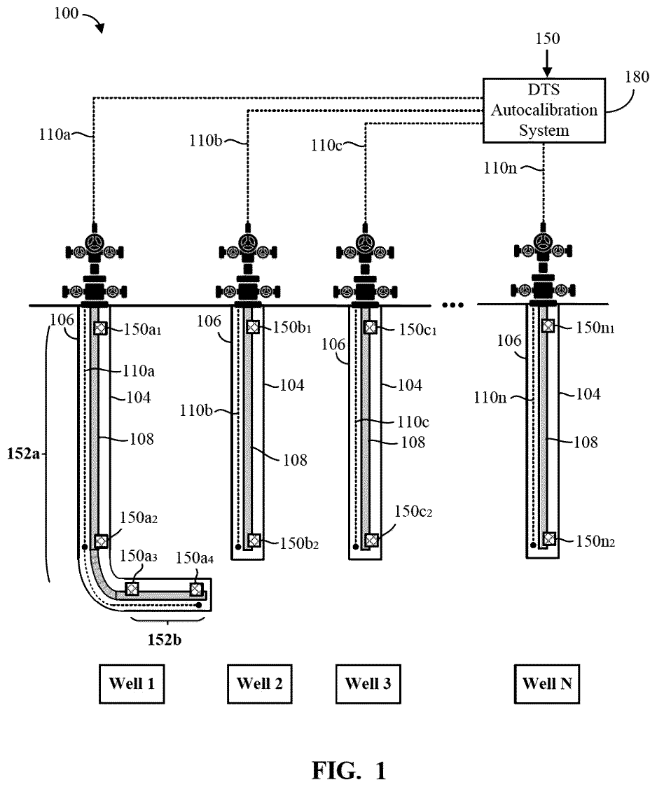

FIG. 1 shows an example oil and gas well environment 100. Environment 100 is a non-limiting example of an environment in which disclosed examples may be deployed.

As shown, environment 100 includes a number of downhole wells 106. Each well 106 may incorporate a DTS system for temperature monitoring across the length of the downhole well.

The DTS system includes one or more fiber-optic cables 110a-110n extending within each wellhole. Each fiber-optic cable 110, for instance, extends from the top to the bottom of the well 106 (or along any portion thereof). The fiber-optic cable 110 can be placed in various locations relative to the wellhole, including in the annulus between the production tubing 108 and the casing, strapped to the outside of the production tubing, inside conduit or control lines, or cemented behind the casing. Disclosed examples are not limited to where the fiber-optic cables 110 are located, or along what portion of the well they are installed.

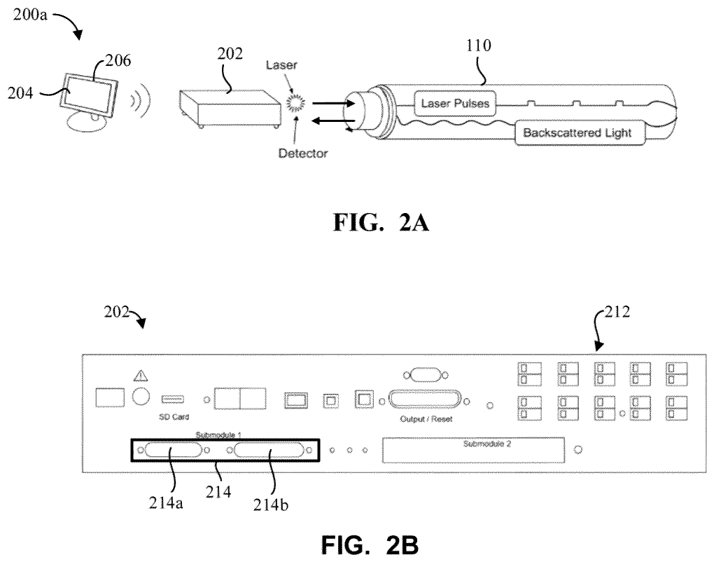

FIG. 2A shows an example DTS system 200a, incorporating a fiber-optic cable 110. The DTS system 200a includes a DTS module 202, which is the main signal processing unit of the system. DTS module 202 optically couples to the fiber-optic cable 110 that runs downhole.

In operation, the DTS module 202 generates laser pulses that travels down the cable 110. Scattered light is reflected back across different portions of the cable 110 and received back at the DTS module 110. The DTS module 110 analyzes properties of the backscattered light, which change depending on the temperature of the cable along its length. The return light can include both Raman anti-Stokes and Stokes signals, which are analyzed to determine length-wise temperature using techniques well known in the art. The resulting temperature profile is displayed on a display interface 206 of a user computer 204, coupled to, or integrated with, the DTS module 202.

In oil and gas applications, DTS technology is particularly useful for real-time monitoring of temperature changes in a well. Real-time temperature monitoring allows detecting issues such as leaks or blockages. It is also used to monitor the effectiveness of treatments or interventions in the well, such as hydraulic fracturing or steam injection. In some cases, DTS technology is also used for monitoring the temperature of the surrounding reservoir, providing information about the reservoir's characteristics and behavior, which can help in optimizing production and extending the life of the well.

Existing DTS systems, however, suffer from important drawbacks. These drawbacks primarily relate to calibration issues affecting the output temperature readings.

Calibration challenges arise from both environmental and system-related factors, including temperature and strain variations, sensor drift, and non-uniform optical fiber responses associated with aging. Additional extrinsic factors such as connectors, splices, and macro- or micro-bending of the fiber cable, as well as intrinsic factors including optical attenuation and light absorption, further degrade calibration accuracy. Over time, these effects cause calibration drift that can lead to erroneous temperature readings.

In oil and gas environments, calibration drift is exacerbated by prolonged exposure of fiber-optic cables to elevated temperatures and hydrogen-rich conditions. Field recalibration in these circumstances is often impractical due to the remote or inaccessible locations of many well sites.

In view of the foregoing, examples herein rely on the use of external temperature sensors for autocalibration of DTS temperature measurement outputs. More generally, there is provided a DTS autocalibration system 180 that is configurable to couple to one or more external temperature sensors 150, as described below.

### III. External Temperature Sensors for Autocaliberation

As exemplified in FIG. 1, each well 106 may include one or more external temperature sensors 150a-150n (also referenced herein as calibrating temperature sensors). The purpose of these sensors is to generate secondary or external temperature data readings at an associated location (or depth) where these sensors are installed (also referenced herein as calibrating temperature data).

Various types of temperature sensors can be used. Non-limiting examples include thermocouples, and other types of resistance and/or capacitance based temperature sensors as known in the art.

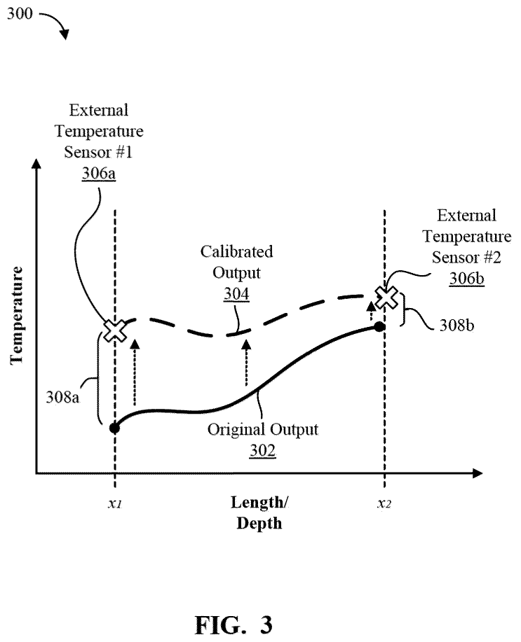

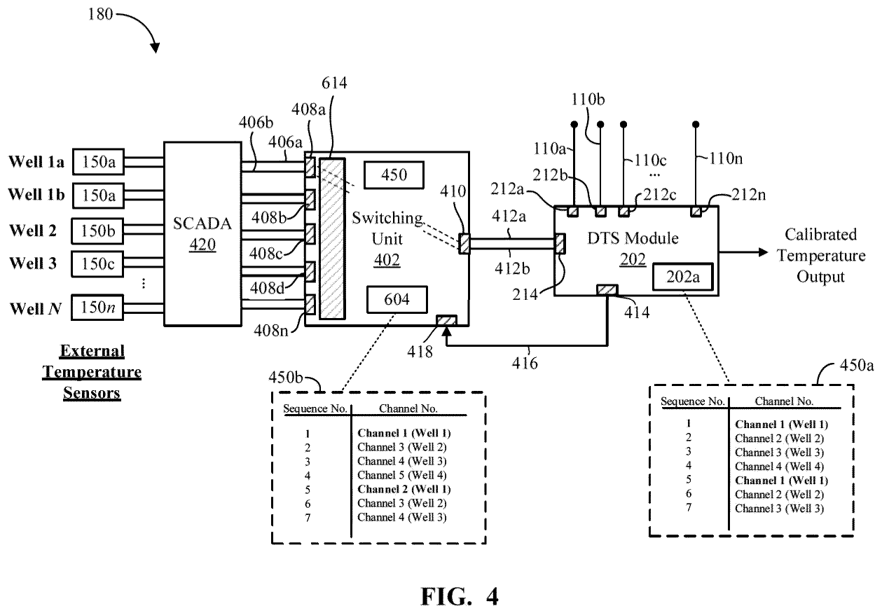

As illustrated in plot 300 of FIG. 3, temperature measurements from the external temperature sensors 150 are used to calibrate the DTS measurements. The original, uncalibrated DTS temperature profile is represented by solid line 302 and is derived from measurements along the fiber-optic cable 110. The external temperature sensors 150 disposed in a given well 106 provide reference calibration temperature data 306a and 306b at corresponding depths x₁ and x₂ within the wellbore.

The system applies gain correction factors 308a and 308b to the DTS uncalibrated temperature data at depths x₁ and x₂ so that they align with the respective calibration temperature data 306a and 306b. Interpolation may then be used to apply gain corrections to the DTS data between depths x₁ and x₂. The resulting calibrated temperature profile 304 is shown as a stippled line.

As used herein, a “temperature profile” refers to the measured temperature across the length of the fiber-optic cable 110 or any portion thereof. In plot 300 (FIG. 3), the length is referenced as “depth” because the fiber-optic cable 110 is generally oriented vertically within the downhole well.

In some examples, each well 106 includes at least a pair of external temperature sensors 150a, 150b. The use of a pair of temperature sensors 150 compensates for attenuation loss that is not always linear across the entire fiber-optic cable 110. This is because the pair of temperature sensors 150 provides at least two calibration points 308a, 308b (FIG. 3) that, in turn, allows interpolating for non-linear gain loss between these two points.

The pair of temperature sensors 150 may be placed at the top and bottom of each well (e.g., 150b₁ and 150b₂ in well “2”, in FIG. 1). This facilitates calibration readings at each extremity, and further facilitates interpolating any readings generated between these two depths. In other examples, only a single temperature sensor 150 is used. In this case, the single temperature sensor provides a calibration point at its corresponding depth. In still other cases, any number of temperature sensors 150 may be deployed.

In some examples, the temperature sensors are disposed proximal, adjacent, or along the respective fiber-optic cable 110 in a given downhole well.

As shown in well “1” (FIG. 1), the wells may also be segmented into different well sections 152a, 152b. This includes a vertical well section 152a and a horizontal well section 152b. Each well section 152a, 152b can include its own set of external temperature sensors 150. For instance, vertical well section 152a is associated with temperature sensors 150a₁, 150a₂, while horizontal well section 152b is associated with temperature sensors 150a₃, 150a₄. An advantage of this setup is to enable calibrating DTS fiber readings from each well section 152, independently.

### IV. DTS Autocaliberation System

As shown in FIG. 1, environment 100 includes a DTS calibration system 180 (FIG. 1). The calibration system 180 functions to apply autocalibration to the fiber-optic temperature data, using calibration data generated by external temperature sensors 150, (e.g., as shown in FIG. 3).

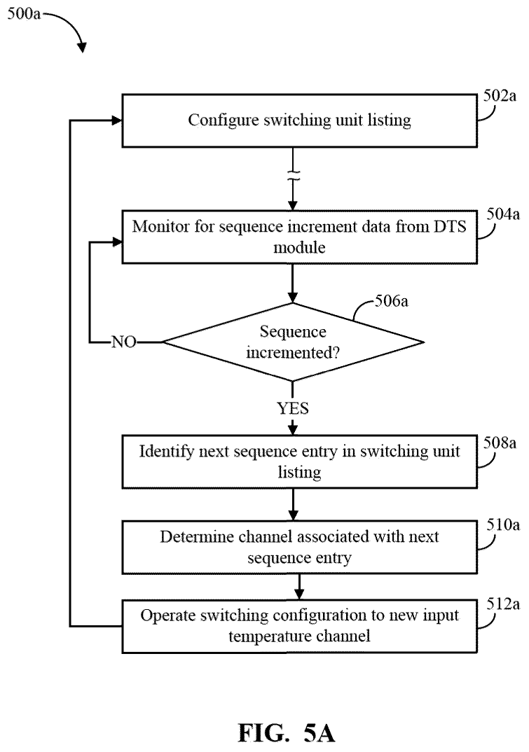

FIG. 4 provides an example hardware architecture for the temperature calibration system 180. As noted, system 180 is used for autocalibration of temperature data from a DTS fiber-optic cable.

As shown, system 180 generally includes a DTS module 202 (e.g., FIG. 2A) coupled to a switching unit 402. In some cases, an intermediate interface 420 is further coupled to the switching unit 402.

### (a.) DTS Module

As shown in FIG. 4, system 180 includes the DTS module 202, as discussed previously. The discussion herein assumes a conventional DTS module and describes it only to facilitate the explanations that follow.

DTS module 202 includes a fiber-optic input interface 212 for coupling to one or a plurality (i.e., two or more) of fiber-optic cables 110a-110n. Each input interface 212a-212n is dedicated to a different fiber-optic cable 110, in the same or a different well 106.

As referenced herein, each input interface 212a-212n is also referred to as an “input fiber-optic channel”. Accordingly, in FIG. 4, the first channel 212a is coupled to fiber-optic cable 110a, the second channel 212b is coupled to fiber-optic cable 110b and so forth. Again, each fiber-optic channel 212 is associated with the same or a different well 106.

DTS module 202 also includes an external input interface 214. In the ordinary course, the external inputs 214 are used for coupling the external calibrating temperature sensors 150 to the DTS module 202.

As best shown in FIG. 2B, however, a conventional DTS module 202 typically includes only two external input interfaces 214a, 214b (or generally, a limited number of input interfaces). This is problematic in the context of deploying the system in environment 100 (FIG. 1). This is because module 202 can only accept a pair of external temperature inputs from only a single well.

Because of this limitation, the DTS module 202 can only calibrate temperature readings associated with a single well 106. This introduces challenges when applying the DTS module 202 to calibrating temperature readings from fiber-optic cables 110 in a plurality of wells. This is because there is not enough external inputs 214, on the DTS module 202, to accommodate temperature sensors 150 from all wells 106. It is also prohibitively expensive to modify the DTS module hardware to accommodate more than the preconfigured available number of external inputs 214a, 214b.

In view of the foregoing, the system 180 also includes the switching unit 402, as described below.

### (b.) Switching Unit

As further exemplified in FIG. 4, switching unit 402 is couplable to the DTS module 202. A primary function of the switching unit 402 is to mitigate for the limited number of external inputs 214a, 214b accepted by the DTS module 202.

More generally, the switching unit 402 acts as an interface between a plurality of temperature sensors 150 in various wells 106, and the DTS module 202. In turn, switching unit 402 enables the DTS module 202 to receive calibration temperature data associated with a plurality of fiber-optic cables 110 located in different wells, or different well sections.

As shown, the switching unit 402 includes its own input interface 408 and an output interface 410. The input interface 408 includes a plurality of input nodes 408a-408n. Each input node 408 receives calibration temperature data from temperature sensors 150 in different wells 106, or different well portions. For example, each input node 408 can receive two input feeds 406a, 406b corresponding to data from a pair of external temperature sensors 150a, 150a in a given well, or well portion.

As referenced herein, each input node 408a-408n in the switching unit 402 is also referred to herein as an “input temperature channel”. Accordingly, first input node 408a corresponds to a first channel, second input node 408b corresponds to a second channel, and so on.

It is possible that different input channels 408 are associated with the same well 106. By way of example, in system 180 (FIG. 4), both input channels 408a, 408b are in fact associated with temperature sensors 150 in the same well “1”. In these cases, the input channels 408a, 408b are associated with different well sections 152 in the same well (FIG. 1). For instance, in FIG. 4, first input channel 408a is associated with temperature sensors 150a₁, 150a₂ in the first vertical well section 152a, of well “1”. Further, second input channel 408b is associated with temperature sensors 150a₃, 150a₄ in the second horizontal well section 152b of well “1”.

It is also not necessary that only two temperature input feeds 406a, 406b are provided per channel 408. For example, each well 106, or well section 152, can include more than two temperature sensors. In these cases, there are a corresponding number of input feeds 406 per temperature sensor, per channel 408.

Continuing with reference to FIG. 4, switching unit 402 couples to the DTS module 202 via an output interface 410. Output interface 410 feeds the external temperature data (e.g., analog temperature data) into the DTS module 202. In this case, only two output feeds 412a, 412a are provided which interface (e.g., couple) to the two external inputs 214a, 214b on the DTS module 202 (FIG. 2B). However, in other cases, any number of output feeds may be provided from the output interface 410 of switching unit 402, to the DTS module 202.

In operation, the switching unit 402 operates to couple one of the input channels 408a of the switching unit 180, to its output interface 410. This allows transmitting data through the switching unit 402 between the coupled input channels and output interface.

For example, the switching unit 402 can couple inputs from the first channel 408a to the output interface 410. This allows transmitting calibration temperature data from the pair of temperature sensors 150a₁, 150a₂ in channel “1” (i.e., well “1”) to the output interface 410. This is then fed into the DTS module 202. At a later point, the switching unit 402 can switch to coupling the second channel 408b to the DTS module 202, and so forth.

Accordingly, the switching unit 402 operates to couple temperature sensors 150, in a plurality of wells 106, to the DTS module 202 one at a time. This allows the DTS module 202 to receive calibration temperature data from different wells (or well sections 152), notwithstanding that its external interface 214 (FIG. 2B) is limited to accepting a limited number of external inputs 214a, 214b.

### (c.) Intermediate Interface

In some examples, an intermediate interface 420 is interposed between the switching unit 402 and the temperature sensors 150. This interface can be a Supervisory Control and Data Acquisition (SCADA) system 420, as known in the art.

In cases where the system incorporates an intermediate interface 420, the switching unit 402 can include a digital to analog (DAC) module 614. The function of the DAC 614 is to convert digital temperature input data, generated by the intermediate interface 420, into analog data. The reason for this is that conventional DTS modules 202 only accept analog data inputs, while the interface 420 may feed digital values to the switching unit 402.

In other examples, the switching unit 402 couples directly to some or all of the temperature sensors 150. In these cases, depending on the coupling method and the type of sensor 150, the switching unit 402 may or may not include a DAC 614 for all or some of the input channels 408.

### V. Sequence-Channel Listings

The following is a discussion of sequence-channel listings that are stored in a memory of each of the DTS module 202, and the switching unit 402. The sequence-channel listings facilitate the interaction between the switching unit 402 and the DTS module 202.

### (a.) Sequence-Channel Listing in DTS Module

As shown in FIG. 4, the DTS module 202 includes a memory 202a. Memory 202a stores a sequence-channel listing 450a (also referred to herein as a “DTS module listing”, a “DTS sequence-channel listing”, or simply, a “DTS listing”). Sequence-channel listing 450a is either preconfigured, or programmed therein.

Sequence-channel listing 450a stores sequential data, on which fiber-optic channel 212a-212n the DTS module 202 is probing at a given time. For example, at time sequence “1” the DTS module 202 activates channel one 212a, and thereby transmits and receives optic signals through the fiber-optic cable 110a (well “1”). Subsequently, at time sequence “2”, the DTS module 202 switches to activate channel two 212b, and transmits and receives optic signals through the fiber-optic cable 110b (well “2”). The channel being probed, at any given time, may be referred to herein as the “active input fiber-optic channel”.

As provided below, the switching unit 402 is synced with the DTS module 202. The synchronization ensures that, at each sequence entry in listing 450a, the switching unit 402 supplies the correct calibration temperature data to the DTS module 202.

For instance, when the DTS module 202 is probing channel one at sequence “1” (i.e., fiber-optic cable 110a in well “1”), the switching unit 402 is synchronized to automatically supply calibration temperature data also from well “1”. This allows the DTS module 202 to auto calibrate the temperature readings from fiber-optic cable 110a based on the calibration temperature data from well “1”.

Likewise, when the DTS module 202 switches to sequence “2” and probes channel two (i.e., fiber-optic cable 110b in well “2”), the switching unit 402 is synchronized to automatically switch to providing temperature data from “well 2”.

### (b.) Synchronization Communication Between DTS Module and Switching Unit

One challenge with synchronizing the switching unit 402 with the DTS module 202 is that conventional DTS modules do not output their current channel, or their current sequence number.

For instance, a conventional DTS module does not output that it is currently probing channel one versus channel two, or that it is on sequence number “3” versus “4” in its listing. This poses problems when interfacing the switching unit 402 with the DTS module 202. This is because the switching unit 402 is unable to ascertain the DTS module's current channel and adjust its switching configuration appropriately.

It has been appreciated, however, that conventional DTS modules do generate “sequence increment data”. This data indicates the DTS module 202 has incremented its sequence to the next sequence number, in its DTS listing 450a.

The DTS module 202 is also able to output any data associated with the active fiber-optic channel 212, including measured or preconfigured data (e.g., minimum and maximum measured temperature, known fiber length, etc.). In view of this, disclosed examples enable the switching unit 402 to use the sequence increment data to synchronize with the DTS module 202.

As shown in FIG. 4, an output data connection 416 couples the DTS module 202 to the switching unit 402. Data connection 416 can include a Modbus TCP/IP connection, as known in the art. The data connection 416 feeds output data from a data interface 414 of the DTS module 202 (also called a DTS module data interface 414), to a data interface 418 of the switching unit 402 (also called a switching unit data interface 418).

Using the data connection 416, the DTS module 202 communicates to the switching unit 402: (i) sequence increment data; and in some examples (ii) data associated with the active fiber-optic channel 212.

### (c.) Sequence-Channel Listing in Switching Unit

On its end, switching unit 402 also includes its own memory 604 that is programmed to include its own sequence-channel listing 450b (also referred to herein as “switching unit sequence-channel listing”, or simply a “switching unit listing”).

Similar to the DTS listing 450a, the switching unit listing 450b comprises sequentially ordered data on input temperature channels 408a-408n to probe at any given time. The input temperature channel being probed at a given time instance is referred to herein as the “active input temperature channel”.

Accordingly, each sequence number, in the listing 450b, identifies an input temperature channel 408. This is the channel 408 that the switching unit 402 couples to its output interface 410 at that sequence increment.

For example, at sequence “1”, the switching unit 402 couples the first input channel 408a to the output interface 410. At sequence “2”, the switching unit 402 switches to couples the third input channel 408c to the output interface 410. Accordingly, the switching unit listing 450b determines the switching configuration of switching unit 410 at any given time instance.

In at least one example, the switching unit listing 450b complements the DTS listing 450a. That is, the sequence channel ordering, in listing 450b, are associated with the same downhole wells, as the well-channel association in DTS listing 450a.

By way of example, in FIG. 4 and in switching unit listing 450b—sequence “1” corresponds to temperature channel one, which couples via SCADA 420 to temperature sensors 150 in well “1”. Likewise, in DTS listing 450b, sequence “1” corresponds to the fiber-optic cable 110a, also in well “1”.

Similarly, in the switching unit listing 450b, sequence “2” corresponds to temperature channel three, which couples via SCADA 420 to temperature sensors 150 in well “2”. Likewise, in the DTS listing 450a, sequence “2” corresponds to the fiber-optic cable 110b, also in well “2”.

By configuring the switching unit listing 450a to complement the DTS listing 450b, the switching unit 402 can synchronize with the DTS module 202. Accordingly, each time the switching unit 402 receives “sequence increment” data from the DTS module 202, via data connection 416—it can increment its own sequence to sync with the DTS module 202. In this manner, the switching unit 402 is always providing external temperature data from the same well that the DTS module 202 is probing at that given sequence number.

In some examples, the switching unit 402 includes a memory buffer 450. Memory buffer 450 can be the same, or different, from memory 604. In operation, memory buffer 450 buffers digital temperature data received on different input temperature channels 408a-408n. This is useful if the intermediate interface 420 (e.g., the SCADA) is transmitting digital temperature data to a given channel 408, however that channel is not yet coupled to the DTS module 202.

### VI. Example Methods for Applying Autocalibration to DTS Measurements

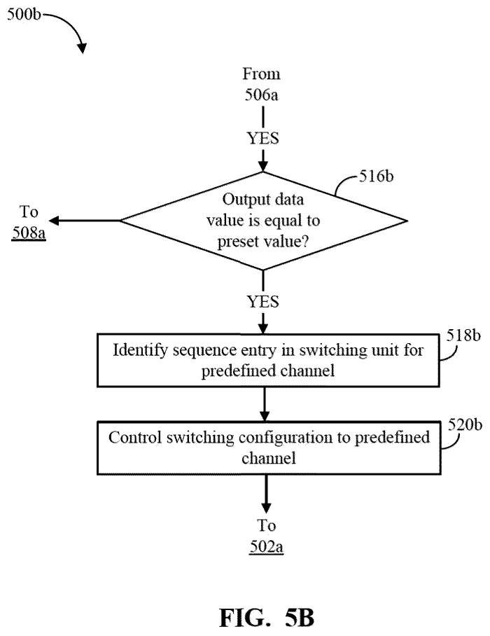

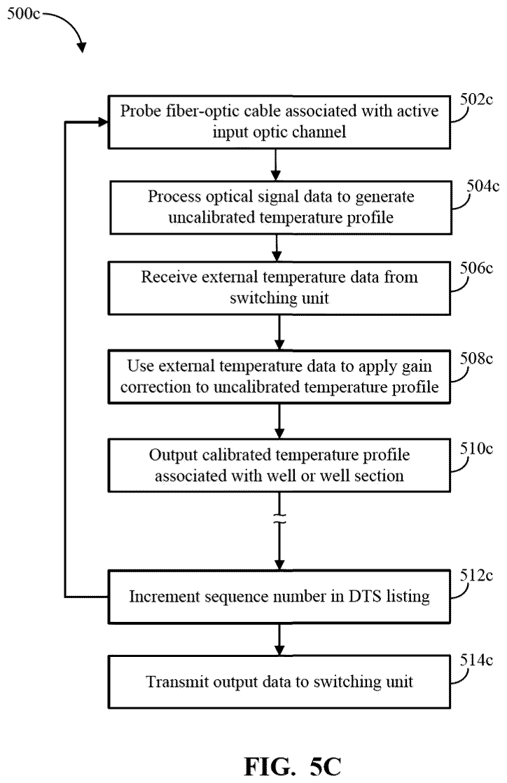

FIGS. 5A-5C are example methods for applying autocalibration to the DTS using the autocalibration system 180.

### (i.) General Method

FIG. 5A shows an example method 500a for applying autocalibration to distributed temperature sensing (DTS) measurements in real time or near real time. In some examples, method 500a is performed by the processor 602 of the switching unit 402 (FIG. 4).

At 502a, the sequence-channel listing 450a (FIG. 4) is stored in the memory 604 of the switching unit 402. In some cases, this involves a user configuring the switching unit 402 (e.g., programming) to store the listing 450b.

As previously described, the switching unit listing 450b is configured to complement the DTS listing 450a. In particular, the sequence order in the switching unit listing 450b is arranged such that each sequence number in listing 450b corresponds to an input temperature channel associated with the same well that the DTS module 202 is probing at that sequence number, according to the DTS listing 450a. In at least one example, the DTS listing 450a is configured prior, or concurrently, with act 502a.

At 504a, the switching unit 402 monitors for sequence increment data received from the DTS module 202.

For instance, as shown in FIG. 4, the switching unit 402 waits for data from data connection 416, that includes a sequence increment data. This indicates to the switching unit 402 that the DTS module 202 has switched from probing one channel to probing the next channel, according to its listing 450a.

At 506a, a determination is made whether the sequence increment data was received. If not, the method returns to 504a to continue monitoring. Otherwise, the method proceeds to 508a.

At 508a, the switching unit 402 identifies the next sequence entry (i.e., next entry) in its sequence-channel listing 450a. For example, if the switching unit 402 is currently on sequence “1”, then the switching unit 402 determines the next increment is sequence “2” and so on.

At 510a, the switching unit 402 identifies the input temperature channel 408 associated with that next sequence entry. For example, in FIG. 4, sequence entry “2” corresponds to temperature channel three. This, in turn, corresponds to the temperature sensors 150c in well “2”.

At 512a, the switching unit 402 adjusts its switching configuration to couple the input temperature channel 408, identified at 510a, to the output interface 410. This allows the switching unit 402 to output calibration temperature data, from each temperature sensor coupled to that channel, to the DTS module 202. As such, the switching unit 402 synchronizes the calibration temperature output with the DTS module 202 in real time, or near real time.

In some cases, at 512a, once the switching unit 402 adjusts its switching configuration, it may pull temperature data from the memory buffer 450 associated with the selected temperature channel 408. It may also apply the DAC 614 to convert the digital temperature input into an analog output.

Method 502a may then return to act 504a to continue monitoring for new sequence increment data from the DTS module 202. If new sequence increment data is not received at 504a-506a, then the switching unit 402 may simply maintain its current switching configuration.

### (ii.) Method for Synchronization Error Correction

In multi-channel DTS deployments, timing or switching misalignment between the switching unit 402 and the DTS module 202 can result in channel synchronization errors, where calibration temperature data is associated with an incorrect input channel or well. The following provides a mechanism to detect and correct such synchronization errors by leveraging known output characteristics of predefined DTS channels.

FIG. 5B illustrates a process flow for an example method 500b for synchronization error correction using the switching unit 402. In some examples, method 500b is performed by the processor 602 of the switching unit 402 (FIG. 4).

At 516b, after the switching unit 402 determines that the channel sequence has incremented (act 506a), the switching unit 402 receives and examines output data generated by the DTS module 202. Such output may be carried via connection 416 (FIG. 4).

In some examples, the DTS module 202 is configured so that, when it probes a predefined fiber-optic channel (for example, channel one), it produces a recognizable and repeatable output value in the transmitted DTS data. This preset value serves as an indicator of which channel is currently being probed by the DTS module 202.

By way of example, when the DTS module 202 probes channel one, it may consistently report a predetermined fiber length for the associated fiber-optic cable 110a (which is stored in the DTS memory), such as 20 meters, regardless of the measured temperature profile.

Accordingly, at 516b, the switching unit 402 analyzes the received output data to determine whether this preset reference value is present. If the preset value is not detected, the switching unit 402 determines that the DTS module 202 is not probing the predefined reference channel and proceeds to act 508a (FIG. 5A).

If the preset value is detected, then at 518b the switching unit 402 determines that the DTS module 202 is currently probing the reference fiber-optic channel. This determination confirms the channel identity associated with the received DTS output data.

Once the predefined reference channel has been identified, the switching unit 402 can use this channel as a synchronization reference. Based on the known channel sequence, the switching unit 402 may then identify a next sequence entry corresponding to a channel that is associated with temperature sensors located in the same well as the reference channel.

At 520b, the switching unit 402 controls its switching configuration to select the identified temperature input channel.

### (iii.) Method for Operating DTS Module

FIG. 5C is an example method 500c for operating the DTS module 202, in conjunction with the switching unit 402. In some examples, method 500c is performed by the processor of the DTS module 202. The DTS processor can be coupled to each of the DTS memory 202a, as well as the input/output interfaces 212, 214 and 414.

At 502c, the DTS module 202 probes (e.g., transmits and receives) optical signal data through a fiber-optic cable 110 associated with an active input fiber-optic channel 212, i.e., associated with a given well 106.

At 504c, the received optical signal data is processed to generate corresponding temperature profile data (e.g., uncalibrated temperature data) This is performed using techniques well known in the art to convert the backscattered signal comprising Raman Stokes and anti-Stokes signals into length/depth wise temperature data. The result of act 504c is then the original uncalibrated output 302 shown in FIG. 3.

At 506c, the DTS module 202 also receives external temperature data (also referred to herein interchangeably as “calibration temperature data”) from the switching unit 402.

As explained, the switching unit 402 is synchronized with the DTS module 202 to transmit calibration temperature data, from temperature sensors 150 in the same well as the fiber-optic cable 110 probed at act 502c. The calibration temperature data, received at 506c, may include two temperature readings, from two temperature sensors 150 in a given well 106 or well section 152 (or any number of temperature readings).

In some examples, the DTS module 202 further determines the position of each calibration temperature data reading. This includes determining at which position, along the length of the fiber-optic cable 110, the temperature reading was captured. The depth of the temperature sensors may be manually input into the DTS module 202, or otherwise predefined therein. It may also be configured in the switching unit 402 and transmitted to the DTS module 202.

At 508c, the calibration temperature data is used to apply a gain correction and generate calibrated temperature data. As shown in FIG. 3, this can be performed by applying gain corrections 308a, 308b to the uncalibrated data 302 at the depth locations of the temperature sensors. It then further includes interpolating (or extrapolating) the gain correction for the remaining data between these depths and/or around those depths.

At 510c, the system outputs the calibrated temperature data (e.g., calibrated temperature profile) associated with a given well, e.g., plot line 304 in FIG. 3. In some cases, this is output back to the SCADA system or any other intermediate interface 420. As shown in FIG. 2A, the output may also be communicated over a communication network (not shown) to an external computing device 204, and displayed on a display interface 206 thereof. The communication network can be a wired or wireless network as known in the art. More generally, the disclosure herein is not limited to the form of output, or on which computing device the output is generated and/or displayed on.

At 512c, at some subsequent time, the DTS module 202 can increment its sequence number, in the DTS listing 450a, to probe the next channel in listing 450a. For example, this may occur after some predefined time interval. The DTS module 202 can then return to probe the new fiber-optic cable 110 in the next DTS channel.

At 514c, upon incrementing, the DTS module 202 transmits output data to the switching unit 402, which includes the sequence increment data. The output data can also include other data associated with the new sequence channel (e.g., measurement data, cable length, etc.).

It is possible that the system may perform 502c prior to act 514c such as to enable the DTS module 202 to output data associated with the channel, to the switching unit 402.

### VII. Alternative and/or Specific Examples

In some examples, the connection between the temperature sensors 150 and the DTS autocalibration system 180 is a wireless connection. In these cases, the sensors 150 communicate with the system 180 via a wireless communication network, as known in the art.

In addition or in the alternative to the examples described above, offsets observed in temperature measurements from certain wells can indicate corresponding offsets in a target well. For example, consistent deviations at common depth intervals across nearby wells—such as a uniform bias at sensor depths or a shift in DTS-derived profiles—may be used to infer and apply offset corrections in the target well. In such cases, the system can identify shared depth references, compare observed temperature offsets across wells, and propagate calibrated offset adjustments to the target well's measurements to improve alignment at those depths.

In some examples, the switching unit 402 as described can be provided standalone. For example, a switching unit 402 can be provided which is couplable directly or indirectly (through the relevant interfaces) to a DTS module 202 and/or the temperature sensors 150. Further, while the data interface 418 has been shown separately from the output interface 410—in some cases, these may be a shared or common interface. The same applies to the input interface 214 and data interface 414 of the DTS module 202. In these cases, it is not necessary to always have a separate data connection 416.

It is also possible that the DTS module 202 is also provided standalone. For example, it may be provided with a memory that stores the method 500c.

Still further, while the discussion herein is applied in the context of an oil and gas well environment, it is understood that the same concepts and principles can be applied to any other environment. For example, this includes any other environment where multiple fiber-optic cables 110a-110n are used for temperature monitoring. For example, this can include applications that involve monitoring various geothermal reservoirs, power cable temperatures in high voltage power lines, environmental monitoring, or temperature monitoring in large industrial facilities. In these cases, the multiple fiber-optic cables are coupled to a DTS autocalibration system 180 and used in conjunction with temperature sensors, as explained herein.

### VIII. Example Hardware Configuration for Switching Unit

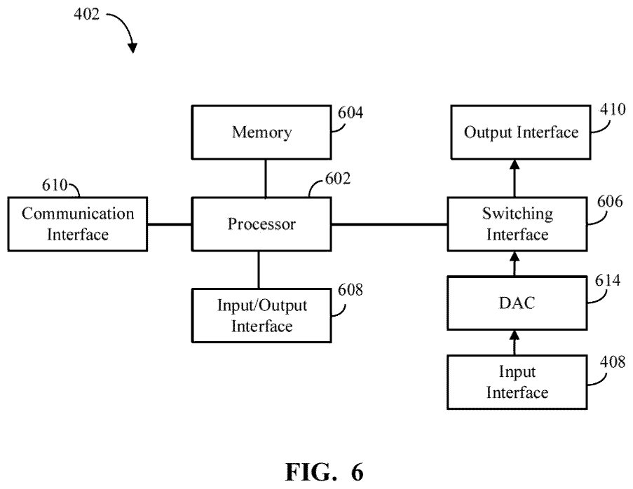

FIG. 6 provides a hardware configuration for an example switching unit 402.

As exemplified, the switching unit 402 can include a processor 602 coupled to a memory 604 and one or more of a switching interface 606, input/output interface 608, and communication interface 610.

Switching interface 606 is itself coupled to the DAC 614 and an output interface 410. In this manner, digital values are received at the input interface 408, processed by the DAC 614, and switched to the correct output interface 410 by the switch interface 606.

In some examples, memory 604 stores the various methods described herein, including methods 500a-500c (FIGS. 5A-5C). Memory 604 may also store the memory buffer 450 (FIG. 4).

It will be understood by those of skill in the art that references herein to processing server 602 as carrying out a function or acting in a particular way imply that processor 602 is executing instructions (e.g., a software program) stored in memory 604 and possibly transmitting or receiving inputs and outputs via one or more interfaces.

Switching interface 606 may be any interface for coupling different input nodes 408 to the output interface 408, and can include various digital or mechanical switches as known in the art. For example, switching interface 606 may be implemented using analog multiplexers, solid-state relays, or electromechanical relays to couple selected input nodes 408 to the output interface 410.

Input/output interface 608 is any interface for coupling to external components.

Communication interface 610 is any interface for communicating over a network, e.g., an antenna.

While not explicitly shown herein, the DTS module 202 may also have a processor coupled to a memory 202a, and a communication interface. Further, the processor may be coupled to the interfaces 212, 214, and 414.

### IX. Interpretation

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method for automated calibration of distributed temperature sensing (DTS) measurements, comprising:
receiving, at a switching unit, sequence increment data from a DTS module,
wherein the DTS module is used for acquiring DTS measurements in a downhole well;
identifying, at the switching unit, a next entry in a sequence-channel listing stored in the switching unit,
wherein the next entry specifies an input temperature channel of the switching unit to probe, the input channel itself coupled to at least one temperature sensor in the downhole well;
adjusting a switching configuration, of the switching unit, to couple the identified input temperature channel to an output interface of the switching unit, the output interface itself coupled to the DTS module; and
transmitting calibration temperature data, through the switching unit, from the at least one temperature sensor to the DTS module, to allow automatic calibration of the DTS measurements by the DTS module.

2. The method of claim 1, further comprising:
receiving new sequence increment data, at the switching unit, from the DTS module; and
repeating the method using a further next entry in the sequence-channel listing.

3. The method of claim 1, wherein the switching unit comprises a plurality of input temperature channels, each coupled to at least one temperature sensor in a different downhole well, or a different portion of a downhole well.

4. The method of claim 3, wherein the sequence-channel listing in the switching unit comprises an ordered sequence of input temperature channels to probe in response to receiving the sequence increment data from the DTS module.

5. The method of claim 4, wherein the DTS module comprises a plurality of input fiber-optic channels, each channel being coupled to a fiber-optic cable deployed in a given downhole well.

6. The method of claim 5, wherein the DTS module also stores a DTS sequence-channel listing, itself defining an ordered sequence of input fiber-optic channels to probe.

7. The method of claim 6, wherein the switching unit listing complements the DTS listing by, for each sequence position, specifying an input temperature channel associated with temperature sensors in the same downhole well as the input fiber-optic channel identified in the DTS listing.

8. The method of claim 6, wherein the method further comprises performing the following at the DTS module, after transmitting the sequence increment data:
processing optical signal data, received from an active input fiber-optic channel,
to generate uncalibrated temperature data;
applying the calibration temperature data, received from the switching unit, to automatically calibrate the uncalibrated temperature data; and
outputting calibrated temperature data.

9. The method of claim 8, wherein the at least one temperature sensor in the downhole well comprises at least a pair of temperature sensors, and each of the pair of temperature sensors is located at a different depth in the downhole well, proximal the fiber-optic cable deployed in that well.

10. The method of claim 9, wherein automatic calibration of the uncalibrated temperature data comprises:
applying a gain correction to the uncalibrated temperature data, at the depths of each temperature sensor; and
interpolating for the uncalibrated temperature data between these depths.

11. A switching unit, comprising:
a plurality of input temperature channels, each channel couplable to at least one temperature sensor in a downhole well;
an output interface and a data interface, each couplable to a DTS module;
a switching interface for coupling one of the input temperature channels to the output interface;
at least one processor coupled to at least one memory and the switching
interface; and
the at least one memory storing a sequence-channel listing as well as computer-executable instructions, which when executed by the at least one processor, cause the at least one processor to perform the method comprising:
receiving sequence increment data from the DTS module, via the data interface;
identifying a next entry in the sequence-channel listing, wherein the next entry specifies an input temperature channel associated with a given downhole well to probe;
adjusting a switching configuration, of the switching interface, to couple the input temperature channel to the output interface; and
transmitting calibration temperature data from the input temperature channel to the DTS module, to allow automatic calibration of DTS measurements acquired by the DTS module for the given downhole well.

12. The switching unit of claim 11, wherein the data interface and the output interface are the same or different interfaces.

13. A system for automated calibration of distributed temperature sensing (DTS) measurements, comprising:
the switching unit of claim 11; and
the DTS module, coupled to the switching unit.

14. The system of claim 13, wherein the DTS module comprises:
a plurality of input fiber-optic channels, each channel couplable to a fiber-optic cable deployed in a downhole well;
an input interface, coupled to the output interface of the switching unit;
a DTS module data interface coupled to the data interface of the switching unit;
at least one memory; and
at least one processor coupled to each of the input fiber-optic channels, input interface, and the DTS module data interface.

15. The system of claim 14, wherein the at least one memory of the DTS module stores a DTS sequence-channel listing defining an ordered sequence of input fiber-optic channels to probe.

16. The system of claim 15, wherein the switching unit listing complements the DTS listing by specifying, for each sequence position, an input temperature channel associated with temperature sensors in the same downhole well as an input fiber-optic channel in the DTS listing.

17. The system of claim 14, wherein the at least one memory of the DTS module stores computer-executable instructions, which when executed by the at least one processor of the DTS module, cause the at least one processor to perform the method comprising:
processing optical signal data, received from the active input fiber-optic channel, to generate uncalibrated temperature data;
applying the calibration temperature data, received from the switching unit, to automatically calibrate the uncalibrated temperature data; and
outputting calibrated temperature data.

18. The system of claim 17, wherein the at least one temperature sensor in the downhole well comprises at least a pair of temperature sensors, and
each of the pair of temperature sensors is located at a different depth in the downhole well, proximal the fiber-optic cable deployed in that well.

19. The system of claim 18, wherein automatic calibration of the uncalibrated temperature data comprises:
applying a gain correction to uncalibrated temperature data, at the depths of each temperature sensor; and
interpolating for the uncalibrated temperature data between these depths.

20. The system of claim 14, wherein the DTS data interface is the same or different from the input interface.
